(19) United States
(12) Patent Application Publication
(10) Pub. No.: US 2025/0081255 A1
(43) Pub. Date: Mar. 6, 2025

(54) Bluetooth communication system, Bluetooth access point apparatus and operation method of the same

(71) Applicant: REALTEK SEMICONDUCTOR CORPORATION, Hsinchu (TW)

(72) Inventors: CHIA-CHUN HUNG, Hsinchu (TW); Li-Ya Huang, Hsinchu (TW); Hsin-Yu Chang, Hsinchu (TW); Yu Chiang, Hsinchu (TW); Po-Sheng Chiu, Hsinchu (TW); Yu-Hsin Lu, Hsinchu (TW)

(21) Appl. No.: 18/819,794

(22) Filed: Aug. 29, 2024

Related U.S. Application Data
(60) Provisional application No. 63/536,119, filed on Sep. 1, 2023.

(30) Foreign Application Priority Data
May 28, 2024 (TW) 113119737

(51) Int. Cl. H04W 76/10; H04W 4/80; H04W 88/08

(52) U.S. Cl. CPC H04W 76/10; H04W 4/80; H04W 88/08

(57) ABSTRACT

The present disclosure discloses a Bluetooth communication system. A first access point apparatus of a Bluetooth access point apparatus performs periodic broadcast communication. A second access point apparatus of the Bluetooth access point apparatus and the first access point apparatus together perform a connection procedure that includes generating connection information related to a to-be-communicated wireless apparatus by the first access point apparatus, receiving the connection information from the first access point apparatus by the second access point apparatus, broadcasting a connection request signal according to the connection information by a first one of the first and the second access point apparatuses to be identified and received by the to-be-communicated wireless apparatus, receiving a connection response signal from the to-be-communicated wireless apparatus by a second one of the first and the second access point apparatuses and establishing connection with the to-be-communicated wireless apparatus by the second access point apparatus.

### BACKGROUND OF THE INVENTION

### 1. Field of the Invention

The present disclosure relates to a Bluetooth communication system, a Bluetooth access point apparatus and a Bluetooth access point operation method of the same.

### 2. Description of Related Art

Bluetooth 5.4 is a new specification published by Bluetooth SIG in 2023. One of the modification of Bluetooth 5.4 that is different from the previous version of the specification is that the periodic advertising with response (PAwR) technology is included to allow a bi-directional communication to be performed between apparatuses under a non-connected communication mode.

Though only a low data amount transmission can be performed based on the periodic advertising with response technology, a large number of wireless apparatuses connected to an access point apparatus still occupy a lot of bandwidth of the access point apparatus such that the access point apparatus can not perform any high data amount transmission with the wireless apparatuses. Such a configuration greatly limits the communication of the Bluetooth communication system.

### SUMMARY OF THE INVENTION

In consideration of the problem of the prior art, an object of the present disclosure is to provide a Bluetooth communication system, a Bluetooth access point apparatus and a Bluetooth access point operation method of the same.

The present invention discloses a Bluetooth access point (AP) apparatus that includes a first access point apparatus and a second access point apparatus. The first access point apparatus is configured to perform a periodic broadcast communication with a plurality of wireless apparatuses according to a periodic advertising with response (PAwR) technology. The second access point apparatus is configured to, together with first access point apparatus, perform a connection procedure such that the second access point apparatus performs a connection communication with a to-be-communicated wireless apparatus of the plurality of wireless apparatuses, the connection procedure including steps outlined below. Connection information related to the to-be-communicated wireless apparatus is generated by the first access point apparatus. The connection information from the first access point apparatus is received by the second access point apparatus. A connection request signal is broadcasted according to the connection information by a first one of the first access point apparatus and the second access point apparatus to be identified and received by the to-be-communicated wireless apparatus. A connection response signal from the to-be-communicated wireless apparatus is received by a second one of the first access point apparatus and the second access point apparatus, wherein the second one of the first access point apparatus and the second access point apparatus is either the same as the first one of the first access point apparatus and the second access point apparatus or different from the first one of the first access point apparatus and the second access point apparatus. Connection is established with the to-be-communicated wireless apparatus by the second access point apparatus.

The present invention also discloses a Bluetooth access point apparatus operation method that includes steps outlined below. A periodic broadcast communication is performed with a plurality of wireless apparatuses according to a periodic advertising with response technology by a first access point apparatus of a Bluetooth access point apparatus. A connection procedure is performed by a second access point apparatus of the Bluetooth access point apparatus together with first access point apparatus, the connection procedure including steps outlined below. Connection information related to a to-be-communicated wireless apparatus of the plurality of wireless apparatuses is generated by the first access point apparatus. The connection information from the first access point apparatus is received by the second access point apparatus. A connection request signal is broadcasted according to the connection information by a first one of the first access point apparatus and the second access point apparatus to be identified and received by the to-be-communicated wireless apparatus. A connection response signal from the to-be-communicated wireless apparatus is received by a second one of the first access point apparatus and the second access point apparatus, wherein the second one of the first access point apparatus and the second access point apparatus is either the same as the first one of the first access point apparatus and the second access point apparatus or different from the first one of the first access point apparatus and the second access point apparatus. Connection is established with the to-be-communicated wireless apparatus by the second access point apparatus. A connection communication is performed with the to-be-communicated wireless apparatus of the wireless apparatuses by the second access point apparatus.

The present invention further discloses a Bluetooth communication system that includes a plurality of wireless apparatuses and a Bluetooth access point apparatus. The Bluetooth access point apparatus includes a first access point apparatus and a second access point apparatus. The first access point apparatus is configured to perform a periodic broadcast communication with the plurality of wireless apparatuses according to a periodic advertising with response technology. The second access point apparatus is configured to, together with first access point apparatus, perform a connection procedure such that the second access point apparatus performs a connection communication with a to-be-communicated wireless apparatus of the plurality of wireless apparatuses, the connection procedure including steps outlined below. Connection information related to the to-be-communicated wireless apparatus is generated by the first access point apparatus. The connection information from the first access point apparatus is received by the second access point apparatus. A connection request signal is broadcasted according to the connection information by a first one of the first access point apparatus and the second access point apparatus to be identified and received by the to-be-communicated wireless apparatus. A connection response signal from the to-be-communicated wireless apparatus is received by a second one of the first access point apparatus and the second access point apparatus, wherein the second one of the first access point apparatus and the second access point apparatus is either the same as the first one of the first access point apparatus and the second access point apparatus or different from the first one of the first access point apparatus and the second access point apparatus. Connection is established with the to-be-communicated wireless apparatus by the second access point apparatus.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1A illustrates a block diagram of a Bluetooth communication system according to an embodiment of the present invention.

FIG. 1B illustrates a timing diagram of the operation of the Bluetooth communication system according to an embodiment of the present invention.

FIG. 2 illustrates a timing diagram that the first access point apparatus and the second access point apparatus perform the connection procedure with the to-be-communicated wireless apparatus according to an embodiment of the present invention.

FIG. 3 illustrates a diagram of a packet of the connection request signal according to an embodiment of the present invention.

FIG. 4 illustrates a timing diagram that the first access point apparatus and the second access point apparatus perform the connection procedure with the to-be-communicated wireless apparatus according to another embodiment of the present invention.

FIG. 5 illustrates a timing diagram that the first access point apparatus and the second access point apparatus perform the connection procedure with the to-be-communicated wireless apparatus according to yet another embodiment of the present invention.

FIG. 6 illustrates a flow chart of a Bluetooth access point apparatus operation method according to an embodiment of the present invention.

### DETAILED DESCRIPTION OF THE PREFERRED EMBODIMENTS

An aspect of the present invention is to provide a Bluetooth communication system, a Bluetooth access point apparatus and a Bluetooth access point operation method of the same to broadcast a connection request signal to a to-be-communicated wireless apparatus by the Bluetooth access point apparatus, receive a connection response signal by the to-be-communicated wireless apparatus in response thereto, and perform a connection communication of a high data amount by a second access point apparatus with the to-be-communicated wireless apparatus such that a first access point apparatus still performs a periodic broadcast communication with wireless apparatuses under a stable bandwidth.

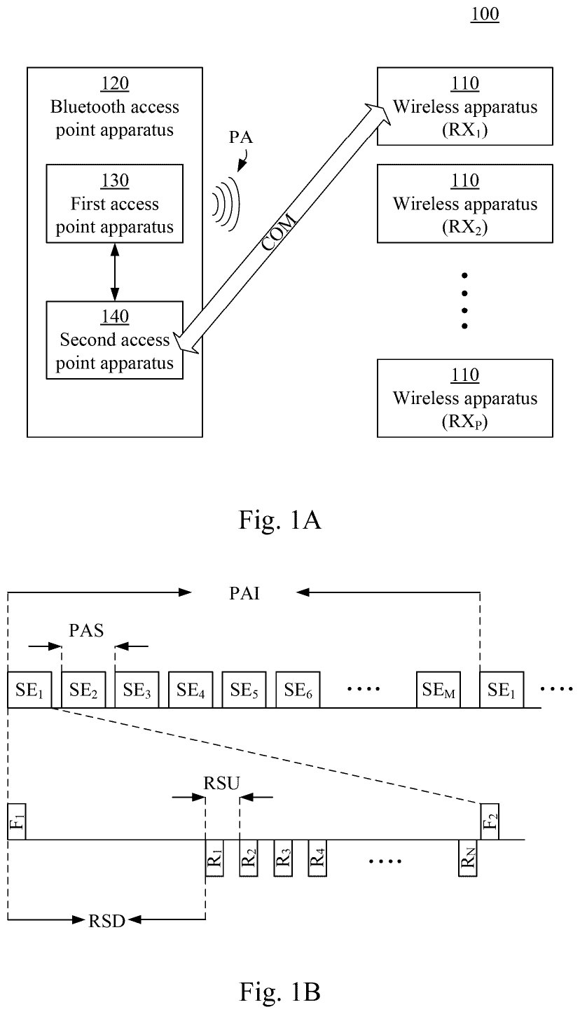

Reference is now made to FIG. 1A and FIG. 1B at the same time. FIG. 1A illustrates a block diagram of a Bluetooth communication system 100 according to an embodiment of the present invention. FIG. 1B illustrates a timing diagram of the operation of the Bluetooth communication system 100 according to an embodiment of the present invention.

As illustrated in FIG. 1A, the Bluetooth communication system 100 includes a plurality of wireless apparatuses 110 and a Bluetooth access point (AP) apparatus 120.

The Bluetooth access point apparatus 120 includes a first access point apparatus 130 and a second access point apparatus 140.

The first access point apparatus 130 is configured to perform a periodic broadcast communication PA with the wireless apparatuses 110 according to a periodic advertising with response (PAwR) technology.

The number of the wireless apparatuses 110 is P and these wireless apparatuses 110 are labeled in FIG. 1A as RX₁˜RX_{P}. Based on the periodic advertising with response technology, the wireless apparatuses 110 can be identified by the first access point apparatus 130 by using different group identification numbers of a plurality of groups that the wireless apparatuses 110 belong to and individual identification numbers of the wireless apparatuses 110 within each of the groups. As a result, the largest number of the wireless apparatuses 110 that can be connected by the first access point apparatus 130 by using the periodic advertising with response technology is determined by the largest amount of the group identification numbers of the groups and the largest amount of the individual identification numbers within each of the groups. In a numerical example, the largest amount of the group identification numbers of the groups is 128 and the largest amount of the individual identification numbers within each of the groups is 255. As a result, the largest amount of the wireless apparatuses 110 that can be connected by the first access point apparatus 130 is 32640(128×255). However, the present invention is not limited thereto.

Under the operation of the periodic advertising with response technology, the first access point apparatus 130 and the wireless apparatuses 110 may perform bi-directional transmission. The first access point apparatus 130 mainly operates as a transmission terminal (TX). Each of the wireless apparatuses 110 mainly operates as a receiving terminal (RX).

More specifically, the first access point apparatus 130 performs periodic broadcasting to poll the wireless apparatuses 110 such that the wireless apparatuses 110 responses according to a predetermined subsequent timing.

As illustrated in FIG. 1B, in one periodic advertising event interval PAI, the first access point apparatus 130 may divide the data to be broadcasted into a plurality of packets periodically transmitted according to every predetermined interval PAS such that each of these packets is transmitted to the wireless apparatuses 110 in one of subevent intervals SE₁˜SE_{M}.

Take the subevent interval SE₁ that is enlarged in FIG. 1B as an example, the first access point apparatus 130 transmits subevent interval information F₁ at a starting point of the subevent interval SE₁. After a time period later than the time point that the wireless apparatuses 110 receives the subevent interval information F₁, in which such a time period is a response slot delay time RSD, at least a part of the wireless apparatuses 110 generate and transmit response information R₀˜R_{N} to the first access point apparatus 130 in response to the subevent interval information F₁. A response slot duration RSU can be configured and disposed between each two of the response information R₀˜R_{N}. After all the wireless apparatuses 110 that are configured to response in the subevent interval SE₁ finish performing the response, the first access point apparatus 130 transmits subevent interval information F₂ marking the beginning of the next subevent interval SE₂.

It is appreciated that different wireless apparatuses 110 may perform response in different subevent intervals SE₁˜SE_{M} according to the configuration thereof. Further, any one of the wireless apparatuses 110 may perform response every one or more than one periodic advertising event interval PA. The present invention is not limited to a certain response method.

In each of the subevent intervals SE₁˜SE_{M} in the periodic advertising event interval PAI, the communication performed between the first access point apparatus 130 and the wireless apparatuses 110 is a low data amount communication. In a numerical example, such a low data amount communication may be performed by using packets each having a payload with a largest size of 251 bytes, in which a size of a plurality of type-length-value (TLV) entries included by the payload is smaller than 48 bytes. It is appreciated that the values described above is merely an example. The present invention is not limited thereto.

In some usage scenarios, a high data amount communication is required to be performed between the first access point apparatus 130 and the wireless apparatuses 110. The term “high data amount” means that the data amount performed under such a condition is higher than the data amount of the communication performed based on the periodic advertising with response technology described above for a certain degree.

For example, each of the wireless apparatuses 110 is an electronic shelf label (ESL) to perform the communication based on the periodic advertising with response technology with the first access point apparatus 130. When any one of the wireless apparatuses 110 needs to update the display content by using an over-the-air (OTA) updating technology, the first access point apparatus 130 can perform the high data amount communication with the wireless apparatuses 110 to provide the data for updating. However, when the amount of the wireless apparatuses 110 that the first access point apparatus 130 is connected to is larger than a predetermined value, the bandwidth may be insufficient due to the high data amount communication performed by the first access point apparatus 130 with any one of the wireless apparatuses 110 such that the broadcast communication performed by the first access point apparatus 130 with the other wireless apparatuses 110 are affected.

The second access point apparatus 140 is configured to, together with first access point apparatus, perform a connection procedure such that the second access point apparatus 140 performs a connection communication COM with a to-be-communicated wireless apparatus of the wireless apparatuses 110, e.g., the wireless apparatus 110 labeled as RX₁.

In an embodiment, the first access point apparatus 130 and the second access point apparatus 140 actively select one of the wireless apparatuses 110 to be the to-be-communicated wireless apparatus to perform the connection procedure with the to-be-communicated wireless apparatus.

In an embodiment, one of the wireless apparatuses 110 serves as the to-be-communicated wireless apparatus to actively transmit a data transmission request signal (not illustrated in the figure) to the first access point apparatus 130 such that the first access point apparatus 130 and the second access point apparatus 140 performs the connection procedure with the to-be-communicated wireless apparatus.

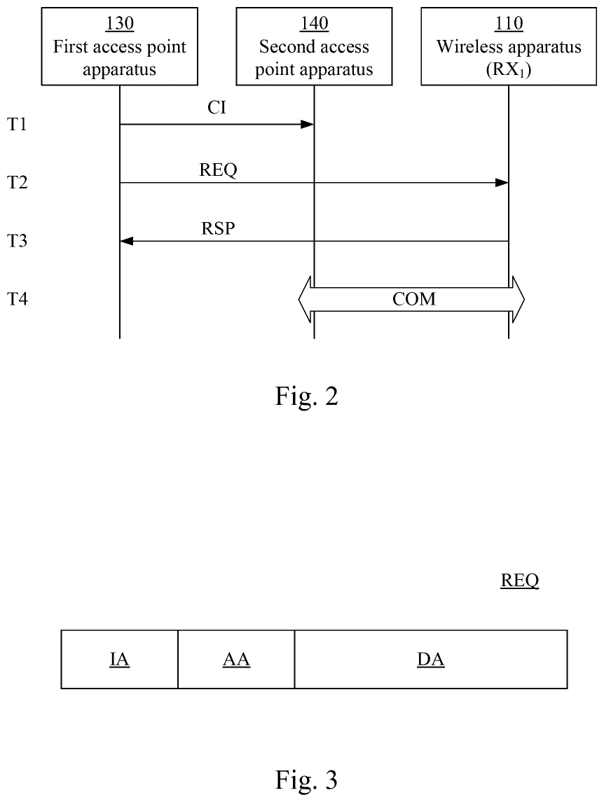

Reference is now made to FIG. 2. FIG. 2 illustrates a timing diagram that the first access point apparatus 130 and the second access point apparatus 140 perform the connection procedure with the to-be-communicated wireless apparatus according to an embodiment of the present invention. In accompany with FIG. 2, the condition that the wireless apparatus 110 labeled as RX₁ operates to be the to-be-communicated wireless apparatus is used as an example to describe the connection procedure in the following paragraphs.

In FIG. 2, the horizontal line sections represent the signal transmission between each pair of the apparatuses. The vertical arrangement of these horizontal line sections from the top to the bottom represents the sequential order of the timings from the earliest to the latest. In FIG. 2, the time points T1˜T4 labeled corresponding to the signals represent the transmission time of these signals.

At the time point T1, the first access point apparatus 130 generates connection information CI related to the to-be-communicated wireless apparatus RX₁. The second access point apparatus 140 receives the connection information CI from the first access point apparatus 130.

The first access point apparatus 130 and the second access point apparatus 140 are connected through a wired network or a wireless network to exchange information. In an embodiment, the connection information CI includes at least one piece of information of address information, connection time information, connection channel information and connection verification information of the first access point apparatus 130 and to-be-communicated wireless apparatus RX₁.

At the time point T2, a first one of the first access point apparatus 130 and the second access point apparatus 140 is configured to broadcast a connection request signal REQ according to the connection information CI to be identified and received by the to-be-communicated wireless apparatus RX₁.

In the present embodiment, based on the periodic advertising with response technology, the first access point apparatus 130 is configured to broadcast the connection request signal REQ through the use of the subevent interval information of the subevent interval at a scheduled timing, in a scheduled channel and with schedule verification information according to the content of the connection information CI. For example, the first access point apparatus 130 may set the content of the subevent interval information F₁ in the subevent interval SE₁ in FIG. 1B to be the content of the connection request signal REQ to broadcast the connection request signal REQ to the wireless apparatuses 110.

Reference is now made to FIG. 3. FIG. 3 illustrates a diagram of a packet of the connection request signal REQ according to an embodiment of the present invention.

In the present embodiment, the packet of the connection request signal REQ includes an initiating terminal address section IA, a broadcast target address section AA and a data section DA. The initiating terminal address section IA includes address information of the apparatus that broadcasts the connection request signal REQ, e.g., the address information of the first access point apparatus 130. The broadcast target address section AA includes the address information of the apparatus that receives the connection request signal REQ, e.g., the address information of to-be-communicated wireless apparatus RX₁.

The data section DA includes information related to the establishment of the connection, e.g., one or more than one of information of an access address randomly generated, an initial value of the cyclic redundancy check (CRC), a transmission window size, a transmission window offset, a connection interval, a delay amount, a timeout, a channel map, a channel hop parameter and a sleep clock accuracy (SCA). However, the present invention is not limited thereto.

Reference is now made to FIG. 2 again. At the time point T3, a second one of the first access point apparatus 130 and the second access point apparatus 140 is configured to receive a connection response signal RSP from the to-be-communicated wireless apparatus RX₁, wherein the second one of the first access point apparatus and the second access point apparatus is either the same as the first one of the first access point apparatus and the second access point apparatus or different from the first one of the first access point apparatus and the second access point apparatus. In the present embodiment, the first access point apparatus 130 is configured to receive the connection response signal RSP.

In an embodiment, the content of the packet of the connection response signal RSP may include one or more than one of information of an event type (e.g., response) of the packet, address information of the apparatus that transmits the connection response signal RSP (e.g., the address information of the to-be-communicated wireless apparatus RX₁), and address information of the apparatus that receives the connection response signal RSP (e.g., the address information of the first access point apparatus 130).

At the time point T4, the second access point apparatus 140 establishes connection with the to-be-communicated wireless apparatus RX₁ to perform the connection communication COM so as to perform high data amount transmission in the connection communication COM. Since the connection communication COM is not restricted to a single signal, the connection communication COM is illustrated as a bi-directional arrow-shaped frame in FIG. 2.

It is appreciated that in the embodiment of FIG. 2, the time point T1 that the second access point apparatus 140 receives the connection information CI from the first access point apparatus 130 is earlier than the time point T2 that the first one of the first access point apparatus 130 and the second access point apparatus 140 broadcasts the connection request signal REQ. However, in some embodiments, the time point T1 that the second access point apparatus 140 receives the connection information CI from the first access point apparatus 130 can be the either later than or the same as the time point T2 that the first one of the first access point apparatus 130 and the second access point apparatus 140 broadcasts the connection request signal REQ.

More specifically, when the second access point apparatus 140 receives the connection information CI at a first time point (corresponding to the time point T1), and the first one of the first access point apparatus 130 and the second access point apparatus 140 broadcasts the connection request signal REQ at a second time point (corresponding to the time point T2), and the second one of the first access point apparatus 130, the second access point apparatus 140 receives the connection response signal REQ at a third time point (corresponding to the time point T3), the second one of the first access point apparatus and the second access point apparatus is either the same as the first one of the first access point apparatus and the second access point apparatus or different from the first one of the first access point apparatus and the second access point apparatus, and either one of the first time point and the second time point is earlier than the other one of the first time point and the second time point or the first time point and the second time point are the same, and both of the first time point and the second time point are earlier than the third time point.

However, both of the first time point and the second time point are earlier than the third time point. The condition that the first time point is earlier than the third time point guarantees that the second access point apparatus 140 receives the connection information CI before the second one of the first access point apparatus 130 and the second access point apparatus 140 receives the connection response signal REQ. On the other hand, since the connection response signal RSP is generated in response to the connection request signal REQ, the second time point is intrinsically earlier than the third time point.

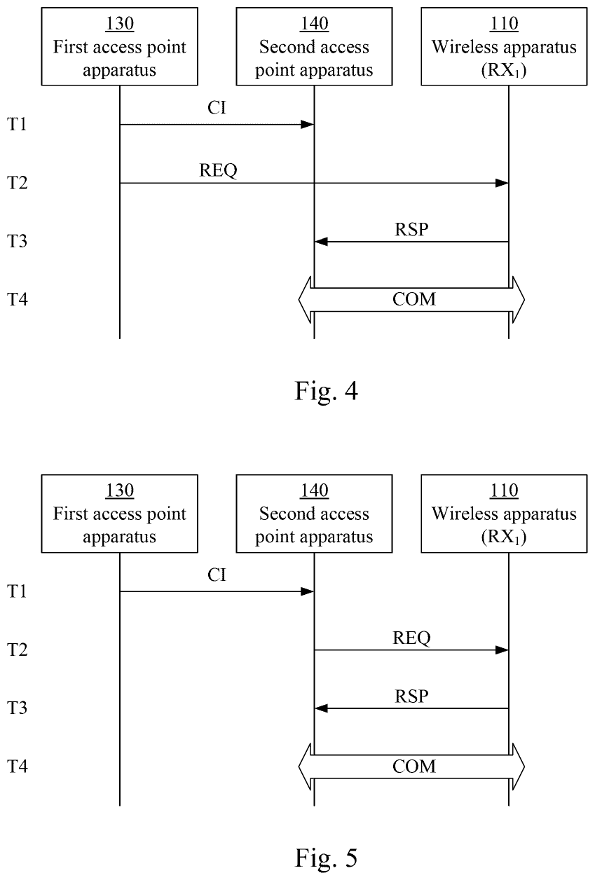

Reference is now made to FIG. 4. FIG. 4 illustrates a timing diagram that the first access point apparatus 130 and the second access point apparatus 140 perform the connection procedure with the to-be-communicated wireless apparatus according to another embodiment of the present invention. Similar to FIG. 2, in FIG. 4, the horizontal line sections represent the signal transmission between each pair of the apparatuses. The vertical arrangement of these horizontal line sections from the top to the bottom represents the sequential order of the timings from the earliest to the latest. In FIG. 4, the time points T1˜T4 labeled corresponding to the signals also represent the transmission time of these signals.

At the time point T1, the first access point apparatus 130 generates the connection information CI related to the to-be-communicated wireless apparatus RX₁. The second access point apparatus 140 receives the connection information CI from the first access point apparatus 130. The method that the first access point apparatus 130 and the second access point apparatus 140 exchange information and the content of the connection information CI are identical to the method and the content described in the embodiment corresponding to FIG. 2. The detail is not described herein.

At the time point T2, the first one of the first access point apparatus 130 and the second access point apparatus 140 is configured to broadcast the connection request signal REQ according to the connection information CI to be identified and received by the to-be-communicated wireless apparatus. In the present embodiment, the first access point apparatus 130 is configured to broadcast the connection request signal REQ, in which the method of broadcasting and the content of the connection request signal REQ are identical to the method and the content described in the embodiment corresponding to FIG. 2. The detail is not described herein.

At the time point T3, the second one of the first access point apparatus 130 and the second access point apparatus 140 is configured to receive the connection response signal RSP from the to-be-communicated wireless apparatus RX₁, the second one of the first access point apparatus 130 and the second access point apparatus 140 is either the same as the first one of the first access point apparatus 130 and the second access point apparatus 140 or different from the first one of the first access point apparatus 130 and the second access point apparatus 140. In the present embodiment, the second access point apparatus 140 is configured to receive the connection response signal RSP, in which the content of the connection response signal RSP identical to the content described in the above embodiment. The detail is not described herein.

At the time point T4, the second access point apparatus 140 establishes connection with the to-be-communicated wireless apparatus RX₁, to perform the connection communication COM, so as to perform high data amount transmission in the connection communication COM.

It is appreciated that in the embodiment in FIG. 4, the time point T1 that the second access point apparatus 140 receives the connection information CI from the first access point apparatus 130 is earlier than the time point T2 that the first one of the first access point apparatus 130 and the second access point apparatus 140 broadcasts the connection request signal REQ. Similar to FIG. 2, in some embodiments, the time point T1 that the second access point apparatus 140 receives the connection information CI from the first access point apparatus 130 can be the either later than or the same as the time point T2 that the first one of the first access point apparatus 130 and the second access point apparatus 140 broadcasts the connection request signal REQ. Further, both of the time point T1 and the time point T2 are earlier than the time point T3. The rationale of the arrangement of the timing order is the same as that described in the embodiment corresponding to FIG. 2. The detail is not described herein.

Reference is now made to FIG. 5. FIG. 5 illustrates a timing diagram that the first access point apparatus 130 and the second access point apparatus 140 perform the connection procedure with the to-be-communicated wireless apparatus according to yet another embodiment of the present invention. Similar to FIG. 2, in FIG. 5, the horizontal line sections represent the signal transmission between each pair of the apparatuses. The vertical arrangement of these horizontal line sections from the top to the bottom represents the sequential order of the timings from the earliest to the latest. In FIG. 5, the time points T1˜T4 labeled corresponding to the signals also represent the transmission time of these signals.

At the time point T1, the first access point apparatus 130 generates the connection information CI related to the to-be-communicated wireless apparatus RX₁. The second access point apparatus 140 receives the connection information CI from the first access point apparatus 130. The method that the first access point apparatus 130 and the second access point apparatus 140 exchange information and the content of the connection information CI are identical to the method and the content described in the embodiment corresponding to FIG. 2. The detail is not described herein.

At the time point T2, the first one of the first access point apparatus 130 and the second access point apparatus 140 is configured to broadcast the connection request signal REQ according to the connection information CI to be identified and received by the to-be-communicated wireless apparatus. In the present embodiment, the second access point apparatus 140 is configured to broadcast the connection request signal REQ in which the method of broadcasting and the content of the connection request signal REQ transmitted by the second access point apparatus 140 are identical to the method and the content described in the embodiment corresponding to FIG. 2 and FIG. 3. The only difference is that the apparatus that performs broadcasting is the second access point apparatus 140. As a result, the detail is not described herein.

At the time point T3, the second one of the first access point apparatus 130 and the second access point apparatus 140 is configured to receive the connection response signal RSP from the to-be-communicated wireless apparatus RX₁. In the present embodiment, the second access point apparatus 140 is configured to receive the connection response signal RSP, in which the content of the connection response signal RSP identical to the content described in the above embodiment. The detail is not described herein.

At the time point T4, the second access point apparatus 140 establishes connection with the to-be-communicated wireless apparatus RX₁, to perform the connection communication COM, so as to perform high data amount transmission in the connection communication COM.

As a result, the Bluetooth communication system of the present invention broadcast a connection request signal to a to-be-communicated wireless apparatus by the Bluetooth access point apparatus, receive a connection response signal by the to-be-communicated wireless apparatus in response thereto, and perform a connection communication of a high data amount by a second access point apparatus with the to-be-communicated wireless apparatus such that a first access point apparatus still performs a periodic broadcast communication with wireless apparatuses under a stable bandwidth.

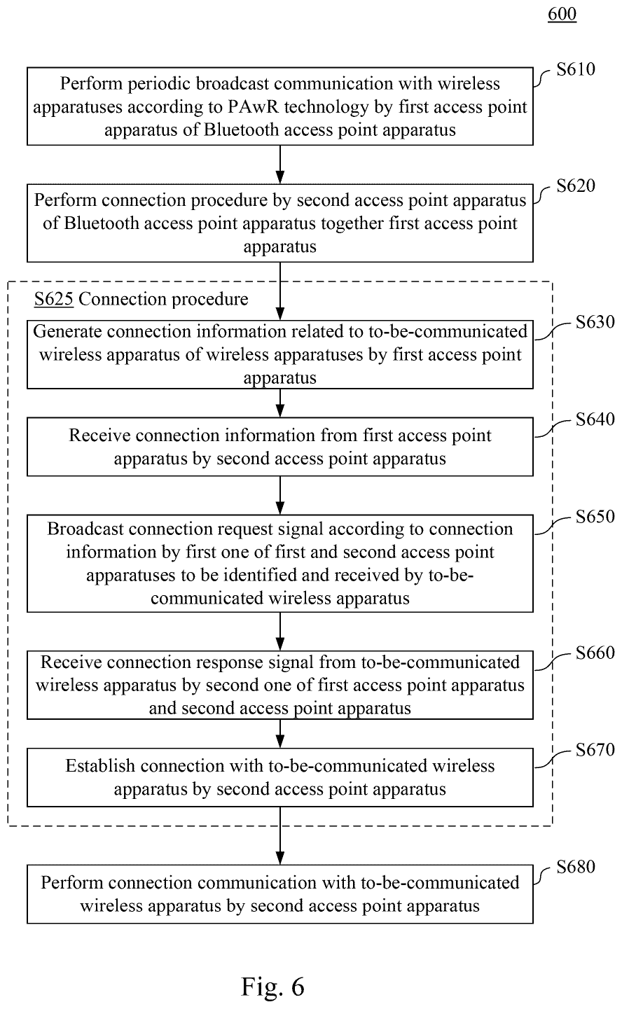

Reference is now made to FIG. 6. FIG. 6 illustrates a flow chart of a Bluetooth access point apparatus operation method 600 according to an embodiment of the present invention.

Besides the apparatus described above, the present invention further discloses the Bluetooth access point apparatus operation method 600 that can be used in such as, but not limited to the Bluetooth access point apparatus 120 illustrated in FIG. 1. An embodiment of the Bluetooth access point apparatus operation method 600 is illustrated in FIG. 6 and includes the steps outlined below.

In step S610, the periodic broadcast communication is performed with the wireless apparatuses 110 according to the periodic advertising with response technology by the first access point apparatus 130 of the Bluetooth access point apparatus 120.

In step S620, the connection procedure S625 is performed by the second access point apparatus 140 of the Bluetooth access point apparatus 120 together with first access point apparatus 130. The connection procedure S625 includes the content described in steps S630˜S670.

In step S630, the connection information CI related to the to-be-communicated wireless apparatus of the wireless apparatuses 110 is generated by the first access point apparatus 130.

In step S640, the connection information CI from the first access point apparatus 130 is received by the second access point apparatus 140.

In step S650, the connection request signal REQ is broadcasted according to the connection information CI by the first one of the first access point apparatus 130 and the second access point apparatus 140 to be identified and received by the to-be-communicated wireless apparatus. It is appreciated that, as described above, the first time point that the second access point apparatus 140 receives the connection information CI from the first access point apparatus 130 is either earlier than or the same as the second time point that the first one of the first access point apparatus 130 and the second access point apparatus 140 broadcasts the connection request signal REQ. As a result, in some embodiments, step S650 can be executed before step S640.

In step S660, the connection response signal RSP from the to-be-communicated wireless apparatus is received by the second one of the first access point apparatus 130 and the second access point apparatus 140, wherein the second one of the first access point apparatus 130 and the second access point apparatus 140 is either the same as the first one of the first access point apparatus 130 and the second access point apparatus 140 or different from the first one of the first access point apparatus 130 and the second access point apparatus 140.

In step S670, a connection is established with the to-be-communicated wireless apparatus by the second access point apparatus 140.

In step S680, a connection communication is performed with the to-be-communicated wireless apparatus by the second access point apparatus 140.

It is appreciated that the embodiments described above are merely an example. In other embodiments, it is appreciated that many modifications and changes may be made by those of ordinary skill in the art without departing, from the spirit of the invention. For example, the wireless apparatus 110 labeled as RX₁ operating as the to-be-communicated wireless apparatus is used as an example. In actual implementation, the embodiments described above can be applied to any one of the wireless apparatuses 110.

In summary, the Bluetooth communication system, the Bluetooth access point and the Bluetooth access point operation method of the same of the present invention broadcast a connection request signal to a to-be-communicated wireless apparatus by the Bluetooth access point apparatus, receive a connection response signal by the to-be-communicated wireless apparatus in response thereto, and perform a connection communication of a high data amount by a second access point apparatus with the to-be-communicated wireless apparatus such that a first access point apparatus still performs a periodic broadcast communication with wireless apparatuses under a stable bandwidth.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A Bluetooth access point (AP) apparatus, comprising:
a first access point apparatus configured to perform a periodic broadcast communication with a plurality of wireless apparatuses according to a periodic advertising with response (PAwR) technology; and
a second access point apparatus configured to, together with first access point apparatus, perform a connection procedure such that the second access point apparatus performs a connection communication with a to-be-communicated wireless apparatus of the plurality of wireless apparatuses, the connection procedure comprising:
generating connection information related to the to-be-communicated wireless apparatus by the first access point apparatus;
receiving the connection information from the first access point apparatus by the second access point apparatus;
broadcasting a connection request signal according to the connection information by a first one of the first access point apparatus and the second access point apparatus to be identified and received by the to-be-communicated wireless apparatus;
receiving a connection response signal from the to-be-communicated wireless apparatus by a second one of the first access point apparatus and the second access point apparatus, wherein the second one of the first access point apparatus and the second access point apparatus is either the same as the first one of the first access point apparatus and the second access point apparatus or different from the first one of the first access point apparatus and the second access point apparatus; and
establishing connection with the to-be-communicated wireless apparatus by the second access point apparatus.

2. The Bluetooth access point apparatus of claim 1, wherein the first access point apparatus is configured to broadcast the connection request signal and the first access point apparatus is configured to receive the connection response signal.

3. The Bluetooth access point apparatus of claim 1, wherein the first access point apparatus is configured to broadcast the connection request signal and the second access point apparatus is configured to receive the connection response signal.

4. The Bluetooth access point apparatus of claim 1, wherein the second access point apparatus is configured to broadcast the connection request signal and the second access point apparatus is configured to receive the connection response signal.

5. The Bluetooth access point apparatus of claim 1, wherein the connection information comprises at least one piece of information of address information, connection time information, connection channel information, connection verification information of the first access point apparatus and the to-be-communicated wireless apparatus.

6. The Bluetooth access point apparatus of claim 1, wherein the first access point apparatus and the second access point apparatus actively perform the connection procedure.

7. The Bluetooth access point apparatus of claim 1, wherein the to-be-communicated wireless apparatus actively transmits a data transmission request signal to the first access point apparatus such that the first access point apparatus and the second access point apparatus perform the connection procedure.

8. The Bluetooth access point apparatus of claim 1, wherein the first access point apparatus and the second access point apparatus are connected through a wired network or a wireless network.

9. The Bluetooth access point apparatus of claim 1, wherein the second access point apparatus receives the connection information at a first time point, the first one of the first access point apparatus and the second access point apparatus broadcasts the connection request signal at a second time point, the second one of the first access point apparatus and the second access point apparatus receives the connection response signal at a third time point;
wherein either one of the first time point and the second time point is earlier than the other one of the first time point and the second time point or the first time point and the second time point are the same, and both of the first time point and the second time point are earlier than the third time point.

10. A Bluetooth access point apparatus operation method, comprising:
performing a periodic broadcast communication with a plurality of wireless apparatuses according to a periodic advertising with response technology by a first access point apparatus of a Bluetooth access point apparatus;
performing a connection procedure by a second access point apparatus of the Bluetooth access point apparatus together with first access point apparatus, the connection procedure comprising:
generating connection information related to a to-be-communicated wireless apparatus of the plurality of wireless apparatuses by the first access point apparatus;
receiving the connection information from the first access point apparatus by the second access point apparatus;
broadcasting a connection request signal according to the connection information by a first one of the first access point apparatus and the second access point apparatus to be identified and received by the to-be-communicated wireless apparatus;
receiving a connection response signal from the to-be-communicated wireless apparatus by a second one of the first access point apparatus and the second access point apparatus, wherein the second one of the first access point apparatus and the second access point apparatus is either the same as the first one of the first access point apparatus and the second access point apparatus or different from the first one of the first access point apparatus and the second access point apparatus;
establishing connection with the to-be-communicated wireless apparatus by the second access point apparatus; and
performing a connection communication with the to-be-communicated wireless apparatus of the wireless apparatuses by the second access point apparatus.

11. The Bluetooth access point apparatus operation method of claim 10, further comprising:
broadcasting the connection request signal by the first access point apparatus and receiving the connection response signal by the first access point apparatus.

12. The Bluetooth access point apparatus operation method of claim 10, further comprising:
broadcasting the connection request signal by the first access point apparatus and receiving the connection response signal by the second access point apparatus.

13. The Bluetooth access point apparatus operation method of claim 10, further comprising:
broadcasting the connection request signal by the second access point apparatus and receiving the connection response signal by the second access point apparatus.

14. The Bluetooth access point apparatus operation method of claim 10, wherein the connection information comprises at least one piece of information of address information, connection time information, connection channel information, connection verification information of the first access point apparatus and the to-be-communicated wireless apparatus.

15. The Bluetooth access point apparatus operation method of claim 10, wherein the first access point apparatus and the second access point apparatus actively perform the connection procedure.

16. The Bluetooth access point apparatus operation method of claim 10, wherein the to-be-communicated wireless apparatus actively transmits a data transmission request signal to the first access point apparatus such that the first access point apparatus and the second access point apparatus perform the connection procedure.

17. The Bluetooth access point apparatus operation method of claim 10, wherein the first access point apparatus and the second access point apparatus are connected through a wired network or a wireless network.

18. The Bluetooth access point apparatus operation method of claim 10, wherein the second access point apparatus receives the connection information at a first time point, the first one of the first access point apparatus and the second access point apparatus broadcasts the connection request signal at a second time point, the second one of the first access point apparatus and the second access point apparatus receives the connection response signal at a third time point;
wherein either one of the first time point and the second time point is earlier than the other one of the first time point and the second time point or the first time point and the second time point are the same, and both of the first time point and the second time point are earlier than the third time point.

19. A Bluetooth communication system, comprising:
a plurality of wireless apparatuses; and
a Bluetooth access point apparatus, comprising:
a first access point apparatus configured to perform a periodic broadcast communication with the plurality of wireless apparatuses according to a periodic advertising with response technology; and
a second access point apparatus configured to, together with first access point apparatus, perform a connection procedure such that the second access point apparatus performs a connection communication with a to-be-communicated wireless apparatus of the plurality of wireless apparatuses, the connection procedure comprising:
generating connection information related to the to-be-communicated wireless apparatus by the first access point apparatus;
receiving the connection information from the first access point apparatus by the second access point apparatus;
broadcasting a connection request signal according to the connection information by a first one of the first access point apparatus and the second access point apparatus to be identified and received by the to-be-communicated wireless apparatus;
receiving a connection response signal from the to-be-communicated wireless apparatus by a second one of the first access point apparatus and the second access point apparatus, wherein the second one of the first access point apparatus and the second access point apparatus is either the same as the first one of the first access point apparatus and the second access point apparatus or different from the first one of the first access point apparatus and the second access point apparatus; and
establishing connection with the to-be-communicated wireless apparatus by the second access point apparatus.
